(19) United States
(12) Patent Application Publication
(10) Pub. No.: US 2015/0046388 A1
(43) Pub. Date: Feb. 12, 2015

(54) SEMANTIC PERCEPTION

(71) Applicants: Amit P. Sheth, Dayton, OH (US); Cory A. Henson, Beavercreek, OH (US); Krishnaprasad Thirunarayan, Beavercreek, OH (US)

(72) Inventors: Amit P. Sheth, Dayton, OH (US); Cory A. Henson, Beavercreek, OH (US); Krishnaprasad Thirunarayan, Beavercreek, OH (US)

(73) Assignee: Wright State University, Dayton, OH (US)

(21) Appl. No.: 14/453,261

(22) Filed: Aug. 6, 2014

Related U.S. Application Data
(60) Provisional application No. 61/863,173, filed on Aug. 7, 2013.

(51) Int. Cl. G06N 5/02

(52) U.S. Cl. CPC G06N 5/022
USPC 706/55

(57) ABSTRACT

Machine semantic perception is discussed. One example system can comprise an environmental knowledgebase (KB) associating features with properties, and an interface component receiving sensor data associated with observed properties. The KB and sensor observations can be encoded in bit-matrix and bit-vector representations, respectively, for efficient storage and computation. A perception component can perform semantic perception on observed properties based on the KB. The perception component can determine explanatory features associated with the observed properties through abductive reasoning, and determine discriminatory properties associated with the explanatory features through deductive reasoning. These can be executed in an iterative and interleaved Perception Cycle for efficient computation of minimum actionable explanations of observations. The bit-matrix and bit-vector representations are presented for efficient computation of minimum actionable explanation using perception cycle, the iterative and interleaved application of hybrid abductive and deductive reasoning to seek contextually relevant discriminatory observations to systematically narrow explanatory features.

### CROSS-REFERENCE TO RELATED APPLICATIONS

This application claims the benefit of pending U.S. Provisional Patent application Ser. No. 61/863,173 (Atty. Dkt. No. 108231.8PRO) entitled ‘SEMANTIC PERCEPTION’ and filed Aug. 7, 2013. The entirety of the above-noted application is incorporated by reference herein.

### TECHNICAL FIELD

The general field of this innovation is converting low-level sensor observations into information supporting human-level comprehension and insight, situational awareness and decision making applications utilizing a resource-constrained device. The process of deriving high-level knowledge from low-level sensory observations provides the context for overcoming information overload and facilitates more natural human-machine interaction within physical-cyber-social systems.

### BACKGROUND

Recent years have seen dramatic advances and adoption of sensor technologies to monitor all aspects of the environment; and increasingly, these sensors are embedded within mobile devices. There are currently over 4 billion mobile devices in operation around the world; and an estimated 25% (and growing) of those are smart devices. Many of these devices are equipped with sensors, such as cameras, GPS, RFID, and accelerometers. Other types of external sensors are also directly accessible to mobile devices through either physical attachments or wireless communication protocols, such as Bluetooth. Mobile applications that may utilize this sensor data for deriving context and/or situation awareness abound. For example, consider a hypothetical mobile device that's capable of communicating with on-body sensors measuring body temperature, heart rate, blood pressure, and galvanic-skin response. The data generated by these sensors may be analyzed to determine a person's health condition and recommend subsequent action. The value of such applications such as these is obvious, yet difficult challenges remain.

The act of observation performed by heterogeneous sensors creates an avalanche of data that must be integrated and interpreted in order to provide knowledge of the situation. This process is commonly referred to as perception, and while people have evolved sophisticated mechanisms to efficiently perceive their environment—such as the use of a-priori knowledge of the environment—machines continue to struggle with the task. From the scenario above, the high-level knowledge of a person's health condition is derived from low-level observation data from on-body sensors.

Emerging solutions to the challenge of machine perception are using ontologies to provide expressive representation of concepts in the domain of sensing and perception, which enable advanced integration and interpretation of heterogeneous sensor data. The W3C Semantic Sensor Network Incubator Group has recently developed the Semantic Sensor Network (SSN) ontology that enables expressive representation of sensors, sensor observations, and knowledge of the environment. The SSN ontology is encoded in the Web Ontology Language (OWL) and has begun to achieve broad adoption within the sensors community. Such work is leading to a realization of a Semantic Sensor Web.

OWL provides an effective solution for defining an expressive representation and formal semantics of concepts in a domain. As such, the SSN ontology serves as a foundation for defining the semantics of machine perception. And given the ubiquity of mobile devices and the proliferation of sensors capable of communicating with them, mobile devices serve as an appropriate platform for executing machine perception. Despite the popularity of cloud-based solutions, many applications may still require local processing, e.g., for privacy concerns, or the need for independence from network connectivity in critical healthcare applications. The computational complexity of OWL, however, seriously limits its applicability and use within resource-constrained environments, such as mobile devices.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

In various embodiments, the subject innovation employs semantic perception technology (e.g., as a machine perception technology, etc.) that provides an ability to convert low-level sensor observations into high-level abstractions supporting human-level comprehension and insight, situational awareness, and decision-making applications. In embodiments disclosed herein, the subject innovation can comprise the following four aspects: (1) a novel encoding of an abductive problem (e.g., in the Web Ontology Language (OWL)), (2) a formal declarative specification of the information processes involved in machine perception, (3) efficient algorithms which implement the declarative specification in order to reason on resource-constrained devices, and (4) lifting and lowering algorithms to translate data encodings between a semantic representation useful for exchanging knowledge on the Web and the bit vector representations used by the efficient algorithms.

In various embodiments, the subject innovation can include systems and methods that can facilitate semantic machine perception. One example system can include an environmental knowledgebase that can associate a set of features with a set of properties, and an interface component that can receive sensor data associated with a set of observed properties, wherein the set of observed properties is a subset of the set of properties. Such a system can also include a perception component that can perform semantic perception on the set of observed properties based on the environmental knowledgebase. The perception component can include an explanation component that can determine a set of explanatory features associated with the set of observed properties, wherein the set of explanatory features is a subset of the set of features that is associated with the set of observed properties. When the set of explanatory features includes at least two explanatory features, the perception component can include a discrimination component that can determine a set of discriminatory properties associated with the set of explanatory features. The set of discriminatory properties can be a subset of the set of properties that is associated with the set of explanatory features, and each discriminatory property of the set of discriminatory properties can discriminate between at least two of the explanatory features.

In another aspect, the subject innovation can include a method, which can include the acts of receiving one or more observed properties and lowering the one or more observed properties to a bit vector representation. Additionally, such a method can include the acts of determining a set of explanatory features based on the one or more observed properties and an environmental knowledgebase that associates a set of properties with a set of features, wherein the set of explanatory features is a subset of the set of features, lifting the set of explanatory features to a semantic representation, and communicating the set of explanatory features. When the set of explanatory features includes two or more explanatory features, such a method can also determine a set of discriminatory properties based on the set of explanatory features, wherein the set of discriminatory properties is a subset of the set of properties. A bit-matrix representation of the knowledge-base and bit-vector representation of observations, explanatory features and discriminatory observations enables the efficient computation of minimum actionable explanations using the perception cycle. The perception cycle is the iterative and interleaved application of hybrid abductive and deductive reasoning to seek contextually relevant discriminatory observations to systematically narrow explanatory features.

In further embodiments, the subject innovation can include a system that can facilitate semantic perception in connection with health information. Such a system can include an environmental knowledgebase that associates a set of medical conditions with a set of health characteristics. Each medical condition of the set of medical conditions can be associated with one or more health characteristics of the set of health characteristics. Additionally, such a system can include an interface component that can receive sensor data associated with a set of observed health characteristics, wherein the set of observed health characteristics is a subset of the set of health characteristics. Such a system can further include a perception component that can perform semantic perception on the set of observed health characteristics based on the environmental knowledgebase. The perception component can include both an explanation component that determines a set of explanatory medical conditions associated with the set of observed health characteristics, wherein the set of explanatory medical conditions is a subset of the set of medical conditions that is associated with the set of observed health characteristics; and a discrimination component that determines a set of discriminatory health characteristics associated with the set of explanatory medical conditions, wherein the set of discriminatory health characteristics is a subset of the set of health characteristics that is associated with the set of explanatory medical conditions, and wherein each discriminatory health characteristic of the set of discriminatory health characteristics discriminates between at least two of the explanatory medical conditions.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

Aspects of the disclosure are understood from the following detailed description when read with the accompanying drawings. It will be appreciated that elements, structures, etc. of the drawings are not necessarily drawn to scale. Accordingly, the dimensions of the same may be arbitrarily increased or reduced for clarity of discussion, for example.

FIG. 1 illustrates a system that can facilitate efficient machine perception in accordance with aspects of the subject innovation.

FIG. 2 illustrates a method of facilitating machine perception in accordance with aspects of the subject innovation.

FIG. 3A illustrates a graphical representation of environmental knowledge in the Semantic Sensor Network, with mappings to DOLCE.

FIG. 3B illustrates an example environmental knowledgebase (KB) with concepts from cardiology.

FIG. 4A illustrates an example KB, from FIG. 3B, which has been lowered to a bit matrix representation.

FIG. 4B illustrates an example index tables for properties associated with the example KB from FIG. 3B.

FIG. 4C illustrates an example index tables for features associated with the example KB from FIG. 3B.

FIG. 5A illustrates an example algorithm that can be employed in connection with aspects of the subject innovation for explanation.

FIG. 5B illustrates an example algorithm that can be employed in connection with aspects of the subject innovation for explanation.

FIG. 6 illustrates results associated with explanation and discrimination evaluations of an OWL implementation and a bit vector implementation of explanation and discrimination tasks, in accordance with aspects of the subject innovation.

FIG. 7 illustrates interactions between patient, clinician, sensors, and a mobile device associated with an example scenario in a healthcare embodiment of the subject innovation.

FIG. 8 illustrates an example implementation of active sensing via a chat dialog in accordance with aspects of the subject innovation.

FIG. 9 illustrates an example user interface showing user notification and example alerts in accordance with aspects of the subject innovation.

FIG. 10 illustrates an example embodiment of a primary user interface screen in accordance with aspects of the subject innovation.

FIG. 11 illustrates observations and detected symptoms accessible via the example user interface in accordance with aspects of the subject innovation.

FIG. 12 illustrates abstractions (or explanations), which are disorders that could be the cause of the observed symptoms (or account for the symptoms), presented via an example user interface in accordance with aspects of the subject innovation.

FIG. 13 illustrates a dialog interface in accordance with an example user interface.

FIG. 14 illustrates an example user interface for a user to manually enter symptoms in accordance with aspects of the subject innovation.

FIG. 15 illustrates a computer-readable medium or computer-readable device comprising processor-executable instructions configured to embody one or more of the provisions set forth herein, according to some embodiments.

FIG. 16 illustrates a computing environment where one or more of the provisions set forth herein can be implemented, according to some embodiments.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component,” “module,” “system,” “interface,” and the like are generally intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a controller and the controller can be a component. One or more components residing within a process or thread of execution and a component may be localized on one computer or distributed between two or more computers.

Furthermore, the claimed subject matter can be implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

While certain ways of displaying information to users are shown and described with respect to certain figures as screenshots, those skilled in the relevant art will recognize that various other alternatives can be employed. The terms “screen,” “web page,” and “page” are generally used interchangeably herein. The pages or screens are stored and/or transmitted as display descriptions, as graphical user interfaces, or by other methods of depicting information on a screen (whether personal computer, smart phone, tablet, or other suitable device, for example) where the layout and information or content to be displayed on the page is stored in memory, database, or another storage facility.

In various aspects, systems and methods of the subject innovation can overcome computational limitations of conventional techniques, and can provide encodings and algorithms for the efficient execution of the inference tasks needed for machine perception: explanation and discrimination. “Explanation” is the task of accounting for sensory observations; often referred to as hypothesis building. This is an abductive task, so to provide an encoding of explanation in OWL, the subject innovation can provide a novel encoding of abduction in OWL. “Discrimination” is the task of deciding how to narrow down the multitude of explanations through further observation. The efficient algorithms presented herein devised for explanation and discrimination use bit vector operations, leveraging environmental knowledge encoded within a two-dimensional bit matrix.

To preserve the ability to share and integrate with knowledge on a communications infrastructure (e.g., the Internet, etc.), the subject innovation can include lifting and lowering mappings between the semantic representations and the bit vector representations. Using these mappings, knowledge of the environment encoded in a Resource Description Framework (“RDF”) (and shared on the Internet, etc., e.g., as Linked Data) may be utilized by lowering the knowledge to a bit matrix representation. On the other hand, knowledge derived by the bit vector algorithms may be shared on the Internet, etc. (e.g., as Linked Data), by lifting to an RDF representation.

The applicability of this approach to machine perception has been evaluated on a smart-phone mobile device in one example embodiment of the subject innovation, demonstrating dramatic improvements in both efficiency and scale. In aspects, the subject innovation can comprise the following aspects that can facilitate efficient machine perception in resource-constrained environments: (1) Novel encoding of an abductive problem in the Web Ontology Language (OWL); (2) Formal declarative specification of two primary inference tasks, in OWL, that are generally applicable to machine perception—explanation and discrimination; (3) Efficient algorithms for explanation and discrimination inference tasks, using bit vector operations; and (4) Lifting and lowering mappings to enable the translation of knowledge between the high-level semantic representations and low-level bit-vector representations.

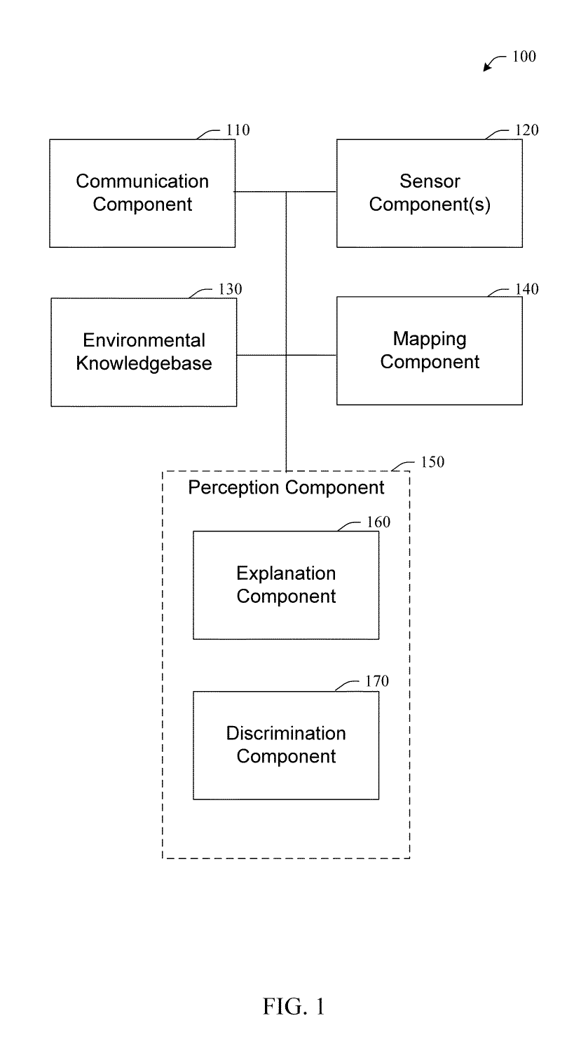

Referring initially to the drawings, FIG. 1 illustrates a system 100 that can facilitate efficient machine perception in accordance with aspects of the subject innovation. System 100 can comprise a communication component 110 that can transmit and receive data associated with system 100. This information can include one or more observed properties, e.g., in the form of sensor data (e.g., from passive or active sensors associated with system 100, for example, in health embodiments, heart rate data, weight data, user inputs, etc.) received by system 100, can include the results of perception performed via system 100 (e.g., potentially explanatory features given a set of observed properties, for example, in health embodiments, potential medical conditions that explain observed symptoms, etc.), etc. In various embodiments, communication component 110 can comprise a user interface that can present information to a user and can receive user inputs.

System 100 can also include, in some embodiments, one or more sensor components 120 that can sense one or more observed properties, and provide this information to communication component 110. Depending on the specific embodiment, these properties can be associated with any of a variety of characteristics. For example, in health embodiments, one or more sensor components 120 can be included within system 100, e.g., as linked (e.g., via BlueTooth, etc.) sensors that observe properties associated with heart rate, galvanic skin response, temperature, etc.

System 100 can also include an environmental knowledgebase 130 that comprises a bipartite graph associating a set of properties (e.g., in health embodiments, health characteristics (e.g., including symptoms, physical characteristics such as weight, gender, heart rate, etc.), etc.) with a set of features (e.g., in health embodiments, conditions, diseases, etc.), wherein each feature of the set of features is associated with one or more properties, which are observable attributes of the feature (e.g., in health embodiments, elevated blood pressure, clammy skin, and palpitations are properties of the feature hyperthyroidism, etc.).

System 100 can also include a mapping component 140 that can translate a semantic representation (e.g., in an RDF, etc.) of properties and features to a bit vector representation via a lowering mapping, or vice versa via a lifting mapping.

System 100 can also include a perception component 150 that can perform machine perception on the set of observed properties in view of the KB, and undertake one or more additional actions based on potential explanatory features. This can include determining one or more explanatory features from among the set of features in environmental knowledgebase 130 (e.g., wherein the set of explanatory features is a subset of the set of features that is associated with the set of observed properties, etc.), based on a set of observed properties received via communication component 110 (either from outside the system or via one or more sensor components 120, etc.), and, when there is more than one explanatory feature in the set of explanatory features, can include determining a set of discriminatory features that discriminate between explanatory features of the set of explanatory features (e.g., wherein the set of discriminatory properties is a subset of the set of properties that is associated with the set of explanatory features, wherein each discriminatory property of the set of discriminatory properties discriminates between at least two of the explanatory features, etc.). Depending on the number and nature of the explanatory features, perception component 150 can iteratively perform explanation and discrimination based on received inputs (via communication component 110) related to discriminatory properties, in order to narrow the set of explanatory features; or, in various embodiments, perception component 150 can analyze the set of explanatory features and, based on the analysis, can instruct communication component 110 to at least one of generate alerts or notifications, or undertake one or more additional actions based on the set of explanatory features (e.g., in healthcare embodiments, a healthcare provider could be notified based on the occurrence of one or more potentially severe conditions in the set of explanatory features, etc.). Perception component 150 can include an explanation component 160 that determines a set of explanatory features as a subset of the set of features, based on the set of observed properties. Perception component 150 can further include a discrimination component 170 that can determine a set of discriminating properties that discriminate between the set of explanatory features when the set of explanatory features comprises two or more explanatory features. In some embodiments, depending on the set of explanatory features, system 100 can generate one or more notifications or alerts, or take one or more appropriate actions (e.g., in health embodiments, alerts might be generated if the set of explanatory features includes one or more features (e.g., conditions) designated as severe, etc., or user notifications can be generated on recommended courses of action to mitigate or seek treatment associated with conditions, notifying a health care provider of the set of explanatory features, contacting emergency services if appropriate and a user is unable to or does not after a designated period of time, etc.).

Based on the set of discriminating features, system 100 can narrow the list of explanatory features via obtaining observed discriminating properties (e.g., observed data associated with at least one of the discriminating properties, etc.) via communication component 110 (e.g., sensor data received remotely or via one or more sensor components 120, via user inputs, for example in response to queries, etc., provided via communication component 110 (e.g., via a user interface, etc.), etc.). Based on the obtained observed discriminatory properties, system 100 can determine a new (e.g., smaller) set of explanatory features and a new (e.g., smaller) set of discriminating properties, and can, depending on the embodiment, either repeat, narrowing the explanatory features until a single explanatory feature is determined Additionally or alternatively, at least one of alerts, notifications, or actions could be implemented based on the set of explanatory features. Furthermore, the perception cycle enables iterative and interleaved application of hybrid abductive and deductive reasoning to seek contextually relevant discriminatory observations to systematically narrow explanatory features.

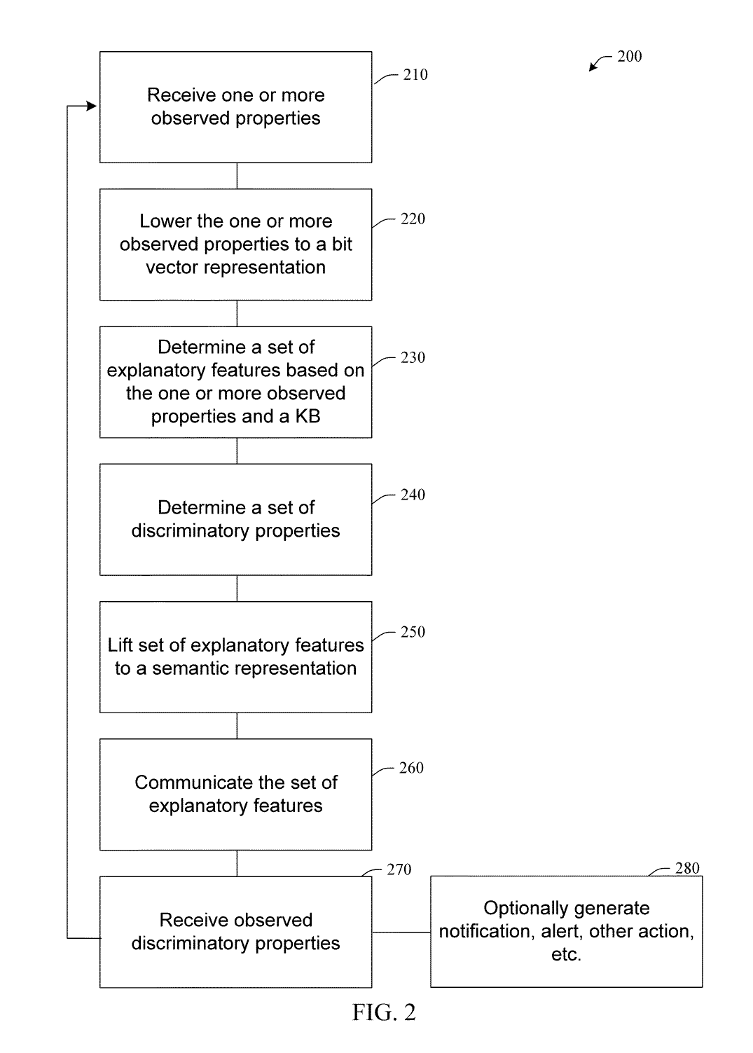

FIG. 2 illustrates a method 200 of facilitating machine perception in accordance with aspects of the subject innovation. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

Method 200 can begin at 210 by receiving a set of observed properties (e.g., as sensor data, as user inputs, etc.). At 220, the set of observed properties can be lowered to a bit vector representation. At 230, a set of explanatory features can be determined based on an environmental knowledgebase and the bit vector representation of the set of observed properties. Next, when the set of explanatory features includes more than one explanatory feature, a set of discriminatory properties can be determined at 240 based on the set of explanatory properties and the environmental knowledgebase, wherein the discriminatory properties discriminate between two or more of the explanatory features of the set of explanatory features. At 250, the set of explanatory features can be lifted to a semantic representation, and at 260, the set of explanatory features can be communicated to a user. At 270, observation data regarding the set of discriminatory properties can be received (e.g., via user input (e.g., in response to a generated query, etc.), via associated sensors, etc.). In some embodiments, the method can return to 220, and the set of explanatory features can be narrowed one or more times. Additionally or alternatively, one or more of notifications, alerts, or additional actions can be generated at 280.

### Abduction in the Web Ontology Language (OWL)

In further aspects, the subject innovation can provide for a novel encoding of an abductive problem in the Web Ontology Language (OWL). In perception, an entity represented as an explanation is not implied by the set of observations, but rather is a hypothetical explanation of the observations. For example, although hyperthyroidism can explain an elevated blood pressure observation, this doesn't necessarily imply the existence of the disorder. Thus, perception isn't a deductive process (in the first-order logic sense of the term), but rather an abductive process, meaning an inference to the best explanation.

Given some background knowledge and a set of observations, an abductive reasoner computes a set of best explanations. In general, abduction is formalized as Σ [symbol] Δ [symbol] Γ, where background knowledge Σ and observations Γ are given, and an explanation Δ is computed ( [symbol] refers to the first-order logic consequence relation).

While OWL has not been specifically designed for abductive inference, it does provide some of the expressivity needed to derive explanations, as demonstrated below.

Parsimonious Covering Theory (PCT) is an abductive logic framework. PCT provides a formal model of diagnostic reasoning that represents knowledge as a network of binary relations. The goal of PCT is to account for observed symptoms (qualities) with plausible explanatory hypotheses (entities). PCT has predominantly been used in medical disease diagnosis. Reasoning in PCT uses a hypothesize-and-test inference process and is driven by background knowledge modeled as a bipartite graph relating entities to qualities.

PCT divides diagnostic reasoning into two parts: coverage and parsimony. The “coverage criterion” describes how to generate a set of explanations such that each observation is accounted for by an entity in the explanation (where an “observation” is a property that has been observed). To reduce the set of explanations to a reasonable size, the “parsimony criterion” describes how to select the best explanations. Researchers have advanced many different parsimony criteria: minimum cardinality criterion, subset minimality (irredundancy) criterion, and so on. The single-entity assumption is a simple yet effective parsimony criterion that has proved popular for medical disease diagnosis. It states that explanations may contain only a single entity.

To formalize the approach of the subject innovation, consider the process of abduction in which background knowledge Σ=(Q, E, C), observations Γ are given, and explanations Δ are to be inferred. Specifically, an abduction problem P (in PCT) is a 4-tuple [symbol] Q, E, C, Γ [symbol] , in which Q is a finite set of qualities, E is a finite set of entities, C:E→Powerset(Q) is the causation function that maps an entity to the corresponding set of qualities it causes, and Γ⊂Q is the set of observations. For any entity e ∈ E and quality q ∈ Q, effects(q)=C(e) and causes(q)={e|q ∈ C(e)}. effects(E)=U_{e∈E} effects(e). The set E_{I}⊂E is said to be a “cover” of Q_{J}⊂Q if Q_{J}⊂effects(E_{I}). A set Δ⊂E is an “explanation” of Γ for a problem (E, Q, C, Γ) if and only if Δ covers Γ and satisfies a given parsimony criterion. A cover E_{I} of Q_{J} is said to be minimal if its cardinality is smallest among all covers of Q_{J}. A cover E_{I} of Q_{J} is said to be irredundant if none of its proper subsets is also a cover of M_{J}.

Thus, an explanation is a “cover” if, for each observation, there is a causal relationship within the background knowledge from a feature contained in the explanation to the observed property. This implicitly uses the one-to-one correspondence between a function over E→Powerset(Q) and its equivalent rendering as a relation over E×Q. An explanation is “parsimonious” (the best) if it contains only a single entity. Thus, an explanation is a parsimonious cover if it contains only a single entity that explains all observations.

Using RDF and OWL to represent information on the Internet—and employing OWL reasoners to infer new information—is gaining support. For this reason, and given the increasing number of observations on the Internet, it makes sense to explore using these languages to model the perception process. However, OWL isn't designed for representing abductive inference. So, existing OWL ontologies have limited ability to formalize perceptions and derive explanations. Nevertheless, OWL does provide some of the expressivity required to derive explanations from observations, and a suitable encoding of PCT in OWL has been developed in connection with the subject innovation. Translating PCT into OWL allows for the use of sensor data in standard Semantic Sensor Web format by adapting OWL reasoning to perform the needed abductive inference.

Prior research has explored integrating OWL with abductive reasoning. However, this integration would require modifying OWL syntax and/or modifying an OWL inference engine. In contrast, aspects of the subject innovation discussed herein demonstrate that OWL provides some of the expressivity needed to derive explanations—without extending its syntax or semantics—by outlining a suitable encoding of PCT in OWL, in accordance with various embodiments. Note, however, that the OWL representation discussed herein only approximates PCT, because OWL inference doesn't support a hypothesize-and-test inference process.

The task of representing PCT in OWL involves encoding the background knowledge Σ and the set of observations Γ in an OWL ontology such that an OWL reasoner can compute explanations Δ that satisfy both the coverage and parsimony criteria. This translation is summarized in Table 1, below:

TABLE 1
Summary of the translation from PCT to OWL.

| | PCT | OWL |
|---|---|---|
| 1 | E | for all e ε E assert Entity(e) |
| 2 | Q | for all q ε Q assert Quality(q) |
| 3 | C | for all q ε C(e) assert causes(e, q) |
| 4 | Γ | Explanation ≡ ∃causes. {q₁} [symbol] . . . [symbol] ∃causes. {qₙ}, |
| | | where qᵢ ε Γ |
| 5 | Δ | for each Δ = {e}, Explanation(e) holds |

To translate the set of entities E, a class Entity was created, and for all e ∈ E, an individual instance of type Entity was created by asserting Entity(e). To translate the set of qualities Q, a class Quality was created, and for all q ∈ Q, an individual instance of type Quality was created by asserting Quality(q). Finally, to translate the set of causes relation instances C, an object property causes was created, and, for all entities in the domain of C and for each q ∈ C(e), a causes fact was created by asserting causes(e, q).

To translate the set of observations Γ into OWL, an observation q₁ ∈ Γ can be selected first and an existentially quantified property restriction for the causes relation, ∃causes. {q₁}, can be created. For each additional observation qᵢ ∈ Γ (i=2, . . . , n), an additional existentially quantified property restriction for the causes relation can be created and conjoined to the previous restriction: ∃causes. {q₁} [symbol] . . . [symbol] ∃causes. {qₙ}. Finally, a class Explanation can be created and defined to be equivalent to the conjunction of restrictions, Explanation ≡ ∃causes.{q₁} [symbol] . . . [symbol] ∃causes.{qₙ}. To generate explanations Δ, a query can be executed for all individual instances of type Explanation as Explanation(?x). Explanation(e) is a result of this query if and only if {e} is a parsimonious cover. The resulting knowledge base lies in the tractable EL profile of OWL 2.

In aspects that generalize the definition of Explanation to allow for covers with multiple disorders, then the parsimony criterion cannot easily be expressed in OWL, since it would require minimization of the extension of a predicate. Simulation by using multiple queries is an option, by incrementally generating cover candidates and checking whether each constitutes an explanation. However, this can be inefficient, and the parsimony criterion itself is not modeled.

### Semantic Sensor Network Ontology

The Semantic Sensor Network (SSN) ontology was developed by the W3C Semantic Sensor Network Incubator Group to serve the needs of the sensors community. This community is currently using it for improved management of sensor data on the Web, involving annotation, integration, publishing, and search. The ontology defines concepts for representing sensors, sensor observations, and knowledge of the environment.

The SSN ontology can serve as a foundation to formalize the semantics of perception. In particular, the representation of observations and environmental knowledge can be employed. An “observation” (ssn:Observation) is defined as a situation that describes an observed feature, an observed property, the sensor used, and a value resulting from the observation, where the prefix “ssn” is used to denote concepts from the SSN ontology. A “feature” (ssn:FeatureOfInterest; or as used herein, ssn:Feature) is an object or event in an environment, and a “property” (ssn:Property) is an observable attribute of a feature. For example, in cardiology, elevated blood pressure is a property of the feature Hyperthyroidism. To determine that blood pressure is elevated requires some pre-processing; this information can be obtained from any of a variety of sources. An observation is related to its observed property through the ssn:observedProperty relation.

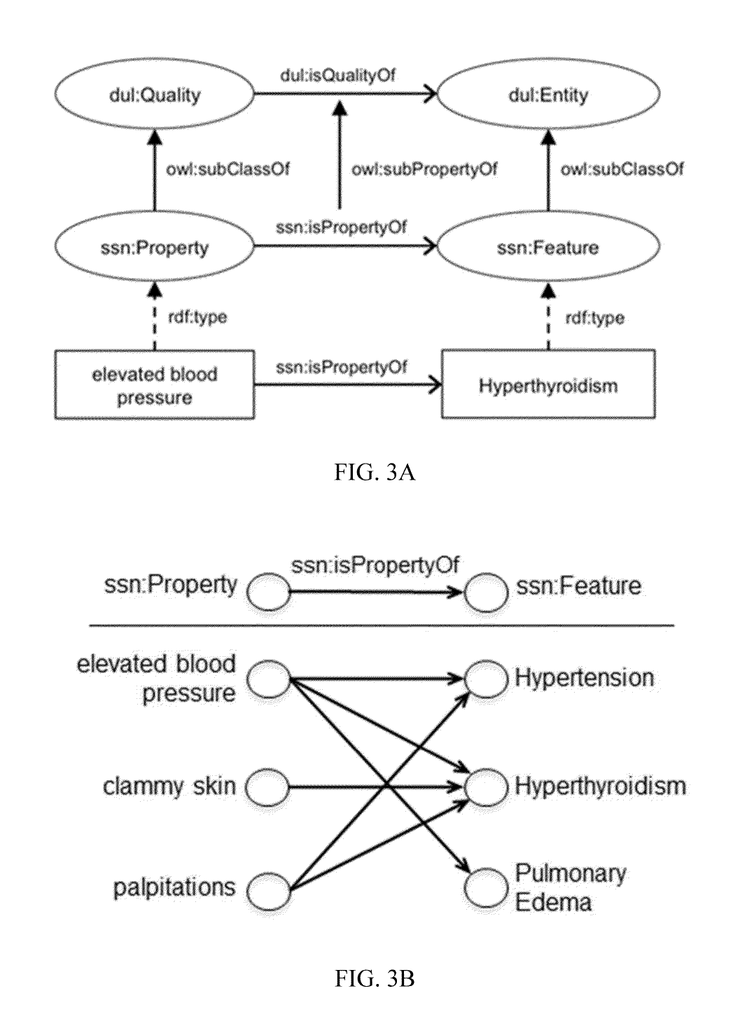

Knowledge of the environment plays a key role in perception. Therefore, the ability to leverage shared knowledge is a key enabler of semantics-based machine perception. In SSN, knowledge of the environment is represented as a relation (ssn:isPropertyOf) between a property and a feature. To enable integration with other ontological knowledge on the Web, this environmental knowledge design pattern is aligned with concepts in the DOLCE Ultra Lite ontology (the prefix “dul” is used to denote concepts from DOLCE Ultra Lite). FIG. 3A illustrates a graphical representation of environmental knowledge in SSN, with mappings to DOLCE. An environmental knowledgebase (or “KB”, as used herein), storing facts about many features and their observable properties, takes the shape of a bipartite graph. FIG. 3B illustrates an example KB with concepts from cardiology.

### Semantics of Machine Perception

Perception is the act of deriving high-level knowledge from low-level sensory observations. The challenge of machine perception is to define computational methods to achieve this task efficiently. Embodiments of the subject innovation define the primary components (inference tasks) of perception in OWL, as an extension of the SSN ontology. The two main components of perception are explanation and discrimination.

“Explanation” is the act of accounting for sensory observations; often referred to as hypothesis building. More specifically, explanation takes a set of observed properties as input and yields the set of features that explain the observed properties. A feature is said to “explain” an observed property if the property is related to the feature through an ssn:isPropertyOf relation. A feature is said to explain a set of observed properties if the feature explains each property in the set. For example, given the KB in FIG. 3B, Hyperthyroidism explains the observed properties elevated blood pressure, clammy skin, and palpitations.

Explanation is used to derive knowledge of the features in an environment from observation of their properties. Since several features may be capable of explaining a given set of observed properties, explanation is most accurately defined as an abductive process (e.g., inference to the best explanation). For example, the observed properties of elevated blood pressure and palpitations, are explained by the features Hypertension and Hyperthyroidism (discussed further below). While OWL has not been specifically designed for abductive inference, embodiments of the subject innovation demonstrate that it does provide some of the expressivity needed to derive explanations.

The formalization of explanation in OWL consists of two steps: (1) derive the set of observed properties from a set of observations, and (2) utilize the set of observed properties to derive a set of explanatory features.

ObservedProperty: An “observed property” is a property that has been observed. Note that observations of a property, such as elevated blood pressure, also contain information about the spatiotemporal context, measured value, unit of measure, etc., so the observed properties need to be “extracted” from the observations. To derive the set of observed properties (instances), a class ObservedProperty can first be created. Next, for each observation o in ssn:Observation, an existentially quantified property restriction for the ssn:observedProperty relation can be created (as used herein, x represents the inverse of relation x), and these can then be disjoined, as in definition (1):

ObservedProperty ≡ ∃ssn:observedProperty-.{o1} ␣ . . . ␣ ∃ssn:observedProperty-.{on} (1)

ExplanatoryFeature: An “explanatory feature” is a feature that explains the set of observed properties. To derive the set of explanatory features, a class ExplanatoryFeature can be created, and for each observed property p in ObservedProperty, an existentially quantified property restriction for the ssn:isPropertyOf- relation can be created and these can be conjoined as in definition (2):

ExplanatoryFeature ≡ ∃ssn:isPropertyOf-.{p₁} [symbol] . . . [symbol] ∃ssn:isPropertyOf-.{pₙ} (2)

To derive the set of all explanatory features, the ObservedProperty class can be created, and the query ObservedProperty (?x) can be executed with an OWL reasoner. Then, the ExplanatoryFeature class can be created, and the query ExplanatoryFeature (?y) can be executed.

For example, assuming that the properties elevated blood pressure and palpitations have been observed, and encoded in RDF (conformant with SSN), then:
ssn:Observation(o1), ssn:observedProperty(o1, elevated blood pressure)
ssn:Observation(o2), ssn:observedProperty(o2, palpitations)
   Given these observations, the following ExplanatoryFeature class can be constructed:
ExplanatoryFeature ≡ ∃ssn:isPropertyOf-.{elevated blood pressure} [symbol] ∃ssn:isPropertyOf-.{palpitations}
   Given the KB in FIG. 3B, executing the query ExplanatoryFeature (?y) can infer the features, Hypertension and Hyperthyroidism, as explanations:
ExplanatoryFeature(Hypertension)
ExplanatoryFeature(Hyperthyroidism)

This encoding of explanation in OWL (as seen in definition (2)) provides an accurate simulation of abductive reasoning in the Parsimonious Covering Theory, with the single-entity assumption (that an explanatory feature is a single. The Description Logic (DL) expressivity of the explanation task is ALCOI (Attributive Language with Complements, Nominals, and role Inverse; using DL constructs: [symbol] , ␣, ∃, {a}, R-), with ExpTime-complete complexity.

“Discrimination” is the act of deciding how to narrow down the multitude of explanatory features through further observation. The innate human ability to focus attention on aspects of the environment that are essential for effective situation-awareness stems from the act of discrimination. Discrimination takes a set of features as input and yields a set of properties. A property is said to “discriminate” between a set of features if its presence can reduce the set of explanatory features. For example, given the KB in FIG. 3B, the property clammy skin discriminates between the features, Hypertension and Hyperthyroidism (as discussed further below).

The ability to identify discriminating properties can significantly improve the efficiency of machine perception. Such knowledge can then be used to task sensors capable of observing those properties.

To formalize discrimination in OWL, three types of properties are defined: “expected property,” “not-applicable property,” and “discriminating property.”

ExpectedProperty: A property is “expected” with respect to (“w.r.t.”) a set of features if it is a property of every feature in the set. Thus, if it were to be observed, every feature in the set would explain the observed property. For example, the property elevated blood pressure is expected w.r.t. the features Hypertension, Hyperthyroidism, and Pulmonary Edema. To derive the set of expected properties, a class ExpectedProperty can be created, and for each explanatory feature f in ExplanatoryFeature, an existentially quantified property restriction for the ssn:isPropertyOf relation can be created, and these can be conjoined as in definition (3):

ExpectedProperty ≡ ∃ssn:isPropertyOf.{f₁} [symbol] . . . ± ∃ssn:isPropertyOf.{fₙ} (3)

NotApplicableProperty: A property is “not-applicable” w.r.t. a set of features if it is not a property of any feature in the set. Thus, if it were to be observed, no feature in the set would explain the observed property. For example, the property clammy skin is not-applicable w.r.t. the features Hypertension and Pulmonary Edema. To derive the set of not-applicable properties, a class NotApplicableProperty can be created, and for each explanatory feature f in ExplanatoryFeature, a negated existentially quantified property restriction for the ssn:isPropertyOf relation can be created, and these can be conjoined as in definition (4):

NotApplicableProperty ≡ [symbol] ∃ssn:isPropertyOf.{f1} [symbol] . . . [symbol] [symbol] ∃ssn:isPropertyOf.{fn} (4)

DiscriminatingProperty: A property is “discriminating” w.r.t. a set of features if it is neither expected nor not-applicable. Observing a discriminating property would help to reduce the number of explanatory features. For example, as stated above, the property clammy skin is discriminating w.r.t. the features Hypertension and Hyperthyroidism, as it would be explained by Hyperthyroidism, but not by Hypertension. To derive the set of discriminating properties, a class DiscriminatingProperty can be created, which is equivalent to the conjunction of the negated ExpectedProperty class and the negated NotApplicableProperty class, as seen in definition (5):

DiscriminatingProperty ≡ [symbol] ExpectedProperty [symbol] [symbol] NotApplicableProperty (5)

To derive the set of all discriminating properties, the ExpectedProperty and NotApplicableProperty classes can be constructed, and the query DiscriminatingProperty(?x) can be executed.

For example, given explanatory features from the previous example, Hypertension and Hyperthyroidism, the following classes can be constructed:

ExpectedProperty ≡ ∃ssn:isPropertyOf.{Hypertension} [symbol] ∃ssn:isPropertyOf.{Hyperthyroidism}

NotApplicableProperty ≡ [symbol] ssn:isPropertyOf.{Hypertension} [symbol] [symbol] ∃ssn:isPropertyOf.{Hyperthyroidism}

Given the KB in FIG. 3B, executing the query DiscriminatingProperty (?x) can infer the property clammy skin as discriminating:
DiscriminatingProperty(clammy skin)

To choose between Hypertension and Hyperthyroidism, a sensor can be tasked to determine the presence or absence of clammy skin (e.g., via measuring galvanic skin response, etc.). The Description Logic expressivity of the discrimination task is ALCO (Attributive Language with Complements and Nominals), with PSpace-complete complexity.

### Efficient Bit Vector Algorithms for Machine Perception

To enable its use on resource-constrained devices, the subject innovation provides algorithms for efficient inference of explanation and discrimination. These algorithms can employ bit vector encodings and operations, leveraging a-priori knowledge of the environment. In various embodiments, the subject innovation need not support reasoning for all of OWL, but supports what is needed for machine perception, which is useful in a variety of applications. Table 2 summarizes the data structures used by algorithms of the subject innovation.

TABLE 2
Quick summary of data structures used by the bit vector algorithms
(note: |x| represents the number of members of x).

| Name | Description | About (type, size) |
|---|---|---|
| KB_{BM} | Environmental knowledge | Bit matrix of size \|ssn:Property\| x |
| | | \|ssn:Feature\| |
| OBSV_{BV} | Observed properties | Bit vector of size \|ssn:Property\| |
| EXPL_{BV} | Explanatory features | Bit vector of size \|ssn:Feature\| |
| DISC_{BV} | Discriminating properties | Bit vector of size \|ssn:Property\| |

To preserve the ability to share and integrate with remote knowledge (e.g., on a communications infrastructure such as the Internet, etc.), lifting and lowering mappings between the semantic representations and bit vector representations can be included in aspects of the subject innovation. Using these mappings, knowledge of the environment encoded in RDF, as well as observed properties encoded in RDF, can be utilized by lowering them to a bit vector representation. Knowledge derived by the bit vector algorithms, including observed properties, explanatory features, and discriminating properties, may be shared on the Web, by lifting them to an RDF representation.

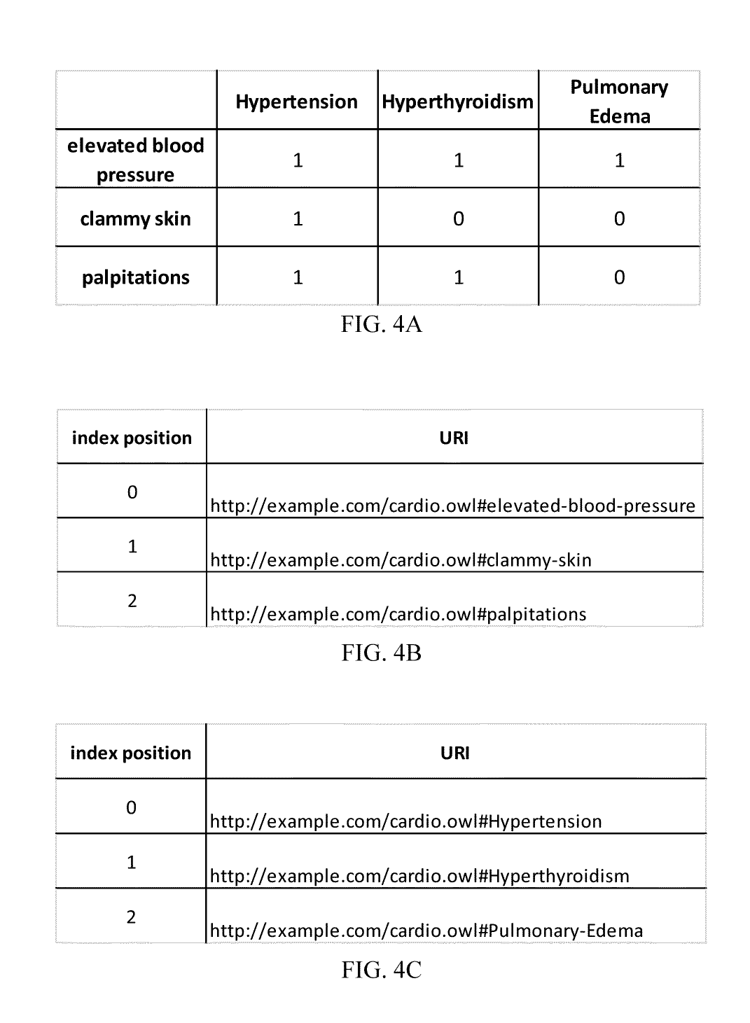

Environmental knowledge: An environmental knowledgebase can be represented as a bit matrix KBBM, for example, with rows representing properties and columns representing features (or transposed, etc.). KB_{BM}[i][j] can be set to 1 (true) iff (if and only if) the property pᵢ is a property of feature fⱼ. To lower an SSN KB encoded in RDF: for all properties pᵢ in ssn:Property, a corresponding row in KB_{BM} can be created, and for all features fⱼ in ssn:Feature, a corresponding column can be created. KB_{BM}[i][j] can be set to 1 iff there exists a ssn:isPropertyOf (pᵢ, fⱼ) relation. FIG. 4A illustrates an example KB, from FIG. 3B, which has been lowered to a bit matrix representation. Index tables are also created to map between the URI's for concepts in the semantic representation to their corresponding index positions in the bit vector representation. FIG. 4B and FIG. 4C show example index tables for properties and features, respectively.

Observed properties: Observed properties can be represented as a bit vector OBSV_{BV}, where OBSV_{BV}[i] can be set to 1 iff property pᵢ has been observed. To lower observed properties encoded in RDF: for each property pᵢ in _{ssn:Property}, OBSV_{BV}[i] can be set to 1 iff _{ObservedProperty(p}_{ᵢ}₎. To lift observed properties encoded in OBSV_{BV}: for each index position i in OBSV_{BV, ObservedProperty(p}_{ᵢ}₎ can be asserted iff OBSV_{BV}[i] is set to 1. To generate a corresponding observation o, an individual o of type _{ssn:Observation, ssn:Observation(o)} can be created, and _{ssn:observedProperty (o,p}_{ᵢ}₎ can be asserted.

Explanatory features: Explanatory features can be represented as a bit vector EXPL_{BV}. EXPL_{BV}[j] can be set to 1 iff the feature fⱼ explains the set of observed properties represented in OBSV_{BV} (that is, it explains all properties in OBSV_{BV} that are set to 1). To lift explanatory features encoded in EXPL_{BV}: for each index position j in EXPL_{BV, ExplanatoryFeature(f}_{ⱼ}₎ can be asserted iff EXPL_{BV}[j] is set to 1.

Discriminating properties: Discriminating properties can be represented as a bit vector DISC_{BV} where DISC_{BV}[i] can be set to 1 iff the property pᵢ discriminates between the set of explanatory features represented in EXPL_{BV}. To lift discriminating properties encoded in DISC_{BV}: for each index position i in DISC_{BV, DiscriminatingProperty(p}_{ᵢ}₎ can be asserted iff DISC_{BV}[i] is set to 1.

### Efficient Bit Vector Algorithm for Explanation

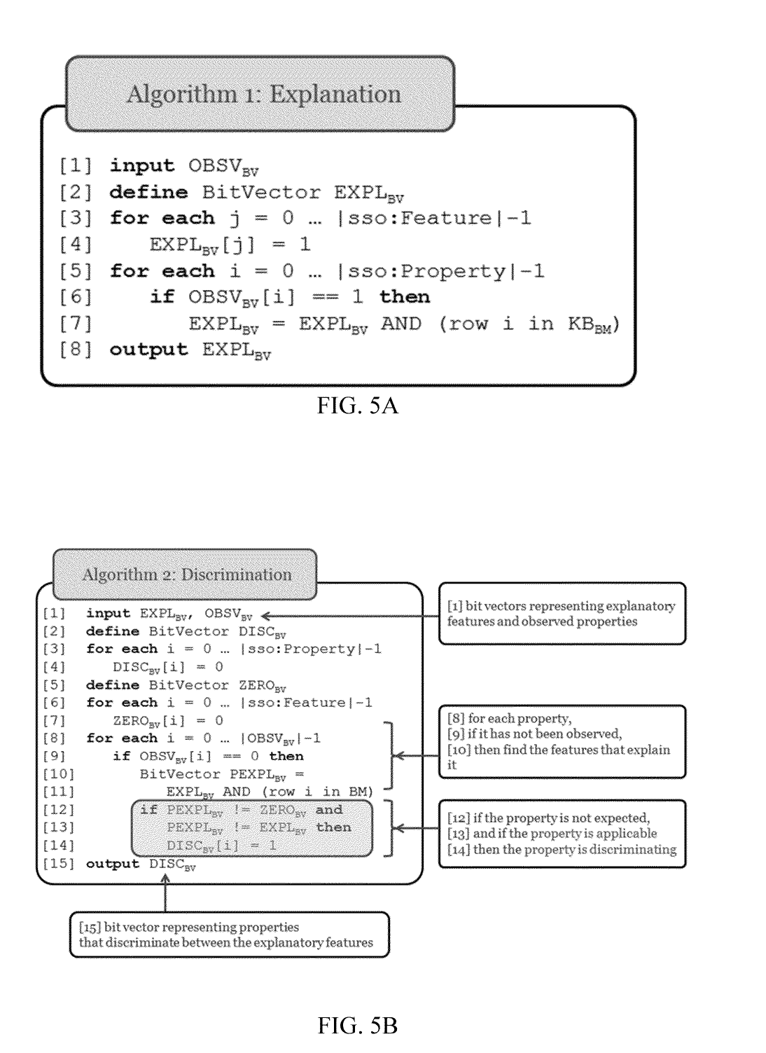

In aspects, the subject innovation can employ a strategy for efficient implementation of the explanation task that relies on the use of the bit vector AND operation to discover and dismiss those features that cannot explain the set of observed properties. Such a strategy can begin by considering all the features as potentially explanatory, and can iteratively dismiss those features that cannot explain an observed property, eventually converging to the set of all explanatory features that can account for all the observed properties. FIG. 5A illustrates an example algorithm that can be employed in connection with aspects of the subject innovation for explanation. In various aspects, the input OBSV_{BV} can be set either directly by the system collecting the sensor data or by translating observed properties encoded in RDF.

Efficient Bit Vector Algorithm from Discrimination

In aspects, the subject innovation can employ a strategy for efficient implementation of the discrimination task that can relies on the use of the bit vector AND operation to discover and indirectly assemble those properties that discriminate between a set of explanatory features. The discriminating properties are those that are determined to be neither expected nor not-applicable.

FIG. 5B illustrates an example algorithm that can be employed in connection with aspects of the subject innovation for discrimination. In the discrimination algorithm, both the discriminating properties bit vector DISC_{BV} and the zero bit vector ZERO_{BV}, can be initialized to zero. For a not-yet-observed property at index ki, the bit vector PEXPL_{BV} can represent one of three situations: (i) PEXPL_{BV}=EXPL_{BV} holds and the ki^{th} property is expected; (ii) PEXPL_{BV}=ZERO_{BV} holds and the ki^{th} property is not-applicable; or (iii) the ki^{th} property discriminates between the explanatory features (and partitions the set). Eventually, DISC_{BV} represents all those properties that are each capable of partitioning the set of explanatory features in EXPL_{BV}. Thus, observing any one of these will narrow down the set of explanatory features.

What follows is a more detailed discussion of certain systems, methods, and apparatuses associated with aspects of the subject innovation. To aid in the understanding of aspects of the subject innovation, theoretical analysis and experimental results associated with specific experiments that were conducted are discussed herein. However, although for the purposes of obtaining the results discussed herein, specific choices were made as to the selection of various aspects of the experiments and associated setups or techniques—such as the choice of implementation or platform, or the selection of abductive task, as well as other aspects—the systems and methods described herein can be employed in other contexts as well. For example, aspects of the subject innovation can employ abductive reasoning to a variety of settings, although the experiments discussed below demonstrate, due to the independence of the results on the nature of the features, properties and observed properties. For example, embodiments of the subject innovation could be employed in medicine for diagnostic purposes. In other examples, the subject innovation can be employed in any of a variety of artificial intelligence or machine perception settings.

To evaluate the subject innovation, two implementations of the explanation and discrimination inference tasks were compared. The first utilized an OWL reasoner as described above, and the second utilized the bit vector algorithms described above. Both implementations were coded in Java, compiled to a Dalvik executable, and run on a Dalvik virtual machine within Google's Android operating system for mobile devices. The OWL implementation uses Androjena, a port of the Jena Semantic Web Framework for Android OS. The mobile device used during the evaluation was a Samsung Infuse, with a 1.2 GHz processor, 16 GB storage capacity, 512 MB of internal memory, and running version 2.3.6 of the Android OS.

To test the efficiency of the two approaches, 10 executions of each inference task wree timed and averaged. To test the scalability, the size of the KB was varied along two dimensions—varying the number of properties and features. In the OWL approach, as the number of observed properties increase, the _{ExplanatoryFeature} class (definition (2)) grew more complex (with more conjoined clauses in the complex class definition). As the number of features increased, the _{ExpectedProperty} class (definition (3)) and _{NotApplicableProperty} class (definition (4)) grew more complex. In the bit vector approach, as the number of properties increase, the number of rows in KB_{BM} grew. As the number of features increase, the number of columns grew.

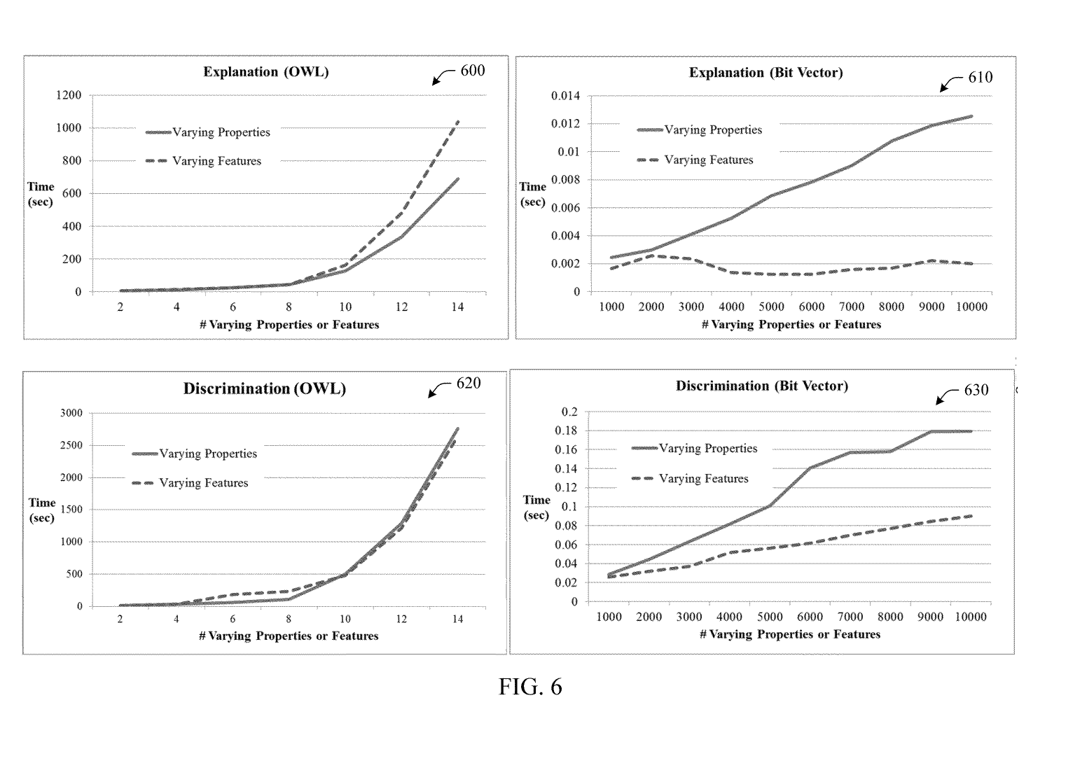

To evaluate worst-case complexity, the set of relations between properties and features in the KB form a complete bi-partite graph. In addition, for the explanation evaluations, every property was initialized as an observed property; for the discrimination evaluations, every feature was initialized as an explanatory feature. This created the worst-case scenario in which every feature was capable of explaining every property, every property needed to be explained, and every feature needed to be discriminated between. FIG. 6 illustrates the results of this evaluation, showing computation times for explanation tasks at 600 (for the OWL implementation, with O(n³) growth) and 610 (for the bit vector implementation, with O(n) growth), and discrimination tasks at 620 (for the OWL implementation, with O(n³) growth) and 630 (for the bit vector implementation, with O(n) growth).

The results from the OWL implementations of explanation and discrimination are shown in 600 and 620, respectively. With a KB of 14 properties and 5 features, and 14 observed properties to be explained, explanation took 688.58 seconds to complete (11.48 min); discrimination took 2758.07 seconds (45.97 min) With 5 properties and 14 features, and 5 observed properties, explanation took 1036.23 seconds to complete (17.27 min); discrimination took 2643.53 seconds (44.06 min) In each of these experiments, the mobile device ran out of memory if the number of properties or features exceeded 14. The results of varying both properties and features showed greater than cubic growth-rate (O(n³) or worse). For explanation, the effect of features dominated; for discrimination, there was not any significant difference in computation time between an increase in the number of properties vs. features.

The results from the bit vector implementations of explanation and discrimination are shown in 610 and 630, respectively. With a KB of 10,000 properties and 1,000 features, and 10,000 observed properties to be explained, explanation took 0.0125 seconds to complete; discrimination took 0.1796 seconds. With 1,000 properties and 10,000 features, and 1,000 observed properties, explanation took 0.002 seconds to complete; discrimination took 0.0898 seconds. The results of varying both properties and features showed linear growth-rate (O(n)); and the effect of properties dominated.

The evaluation demonstrated orders of magnitude improvement in both efficiency and scalability. The inference tasks implemented using an OWL reasoner both showed greater than cubic growth-rate (O(n³) or worse), and took many minutes to complete with a small number of observed properties (up to 14) and small KB (up to 19 concepts; #properties+#features). While there exists the possibility that Androjena may have shortcomings (such as an inefficient reasoner and obligation to compute all consequences), the OWL results are in line with prior analysis that also found OWL inference on resource-constrained devices to be infeasible. On the other hand, the bit vector implementations showed linear growth-rate (O(n)), and took milliseconds to complete with a large number of observed properties (up to 10,000) and large KB (up to 11,000 concepts).

One possible application of embodiments of the subject innovation involves a mobile application in which a person's health condition is derived from on-body sensors. A person's condition should ideally be determined quickly, i.e., within seconds (at the maximum), so that decisive steps can be taken when a serious health problem is detected. Also, for an application to detect a wide range of disorders (e.g., features) from a wide range of observed symptoms (e.g., properties) the KB should be of adequate size and scope. In practice, an application may not require a KB of 11,000 concepts; however, many applications would require more than 19 concepts.

The comparison between the two approaches is dramatic, showing asymptotic order of magnitude improvement; with running times reduced from minutes to milliseconds, and problem size increased from 10's to 1000's. For the explanation and discrimination inference tasks executed on a resource-constrained mobile device, the evaluation highlights both the limitations of OWL reasoning and the efficacy of specialized algorithms utilizing bit vector operations.

The bit vector encodings and algorithms of the subject innovation yield significant and necessary computational enhancements—including asymptotic order of magnitude improvement, with running times reduced from minutes to milliseconds, and problem size increased from 10's to 1000's. The subject innovation was prototyped and evaluated on a mobile device, with promising applications of contemporary relevance (e.g., healthcare/cardiology). As the number and ubiquity of sensors and mobile devices continue to grow, the need for computational methods to analyze the avalanche of heterogeneous sensor data and derive situation awareness will grow, increasing the applications of the efficient and scalable approach to semantics-based machine perception of the subject innovation.

In various embodiments, the subject innovation can comprise a (semantic) Web 3.0 application development framework with the ability to create Health 3.0 applications (or can comprise such applications, in some embodiments). These embodiments can integrate data from passive and active sensing (e.g., including both machine and human sensors) with background knowledge from domain ontologies, semantic reasoning, and mobile computing environments to help people make decisions to improve health, fitness, and wellbeing. Applications can be specialized to run on mobile devices, cloud-mobile environments, or traditional client-server infrastructure.

Sensors and mobile computing devices are increasingly being used to monitor and manage personal health. Low-cost (sub-$100), unobtrusive on-body sensors can passively track health-related signals such as heart rate, temperature, galvanic skin response, and activity level. Mobile computing devices and applications can wirelessly collect the sensor data, process the data, and interact with the user. Quantified Self, a growing group of individuals using low-cost sensors and mobile apps to track health metrics and share their experiences, exemplifies the trend. This technology has been successful in monitoring and managing simple conditions, i.e., those that can be monitored using a single sensor. The monitoring of complex conditions, such as chronic heart failure, however, involves multiple sensors of different modalities. The data from even a few multimodal sensors can quickly become too complex and confusing for a patient and too time-consuming for a clinician. What is needed is a process to convert the low-level data to high-level knowledge useful for understanding health-related concepts that are relevant to decision-making. To address this, embodiments of the subject innovation can utilize a semantics-based approach to convert data to knowledge through the integration of heterogeneous data and application of perceptual inference. In various aspects, the subject innovation can achieve this by leveraging multiple technologies, including inexpensive and unobtrusive health sensors, mobile computing platforms, and maturing semantic technologies.

Embodiments of the subject innovation can be embodied in a framework that integrates data from passive sensors (e.g., on-body sensors), active sensors (e.g., sensors available at home—weight scale, blood pressure monitor, etc.—and personal observation), and medical background knowledge. This heterogeneous integrated data can be utilized by embodiments of the subject innovation to generate explanations of the low-level physiological data, resulting in high-level knowledge useful for decision-making.

Semantic integration and abstraction are effective methods for enabling users and clinicians to find clinically relevant knowledge from multimodal sensing.

Hospital readmission of patients suffering from chronic conditions, such as heart failure, is a growing concern, affecting up to 24.8% of patients and costing $17.4 billion per year. Heart failure is a chronic disease that affects more than 5 million people in the United States, and more than 550,000 new cases are diagnosed each year. It accounts for nearly 1.2 million hospitalizations a year as the primary diagnosis and from 2.4 to 3.6 million as a primary or secondary diagnosis. With an aging population, the incidence and prevalence of heart failure is expected to increase. The estimated cost of heart failure in the US for 2008 is $34.8 billion. Approximately 50% of patients are readmitted within 6 months after the index case of heart failure and 70% of readmissions are related to worsening of the previously diagnosed heart failure. The average rate of readmission within 30 days of discharge for heart failure is 24.8%. Because of the seriousness of this problem, 30-day post-discharge heart failure readmission rates are now being considered as major quality measures for hospitals. In fact, the Patient Protection and Affordable Care Act includes financial penalties for hospitals with high numbers of preventable readmissions.

A major challenge in conventional healthcare is the inability to adequately predict worsening heart failure using either patient self-monitoring or remote telemonitoring of symptoms and daily weight. Conventional solutions to this problem employ traditional intervention strategies, such as checkup within 7 days, use of in-body sensors requiring additional surgery at significant expense, and/or remote-monitoring and telemedicine (e.g., involving sensors/equipment that are often very (prohibitively) expensive). The degree of additional commitment (e.g., time and money) required from both the patient and the health professionals have impeded adoption of these solutions.

The following is an example scenario implementing an embodiment of the subject innovation. In this example scenario, John has been hospitalized over the past five days for Acute Decompensated Heart Failure (ADHF). Unfortunately, patients discharged post-ADHF are frequently readmitted due to poor adherence to both the prescribed medications and low sodium diet. To reduce the risk of readmission over the next 30 days post-discharge, John will be supplied with remote monitoring sensors and a mobile app to help monitor his health. These sensors can measure heart rate, breathing rate, skin temperature, movement, galvanic skin response, electrocardiogram (ECG), weight, blood pressure, and pulse oximetry (SpO₂). By monitoring his physiological status through these sensors, the possible deterioration of John's health can be detected, prior to reaching the point of readmission.

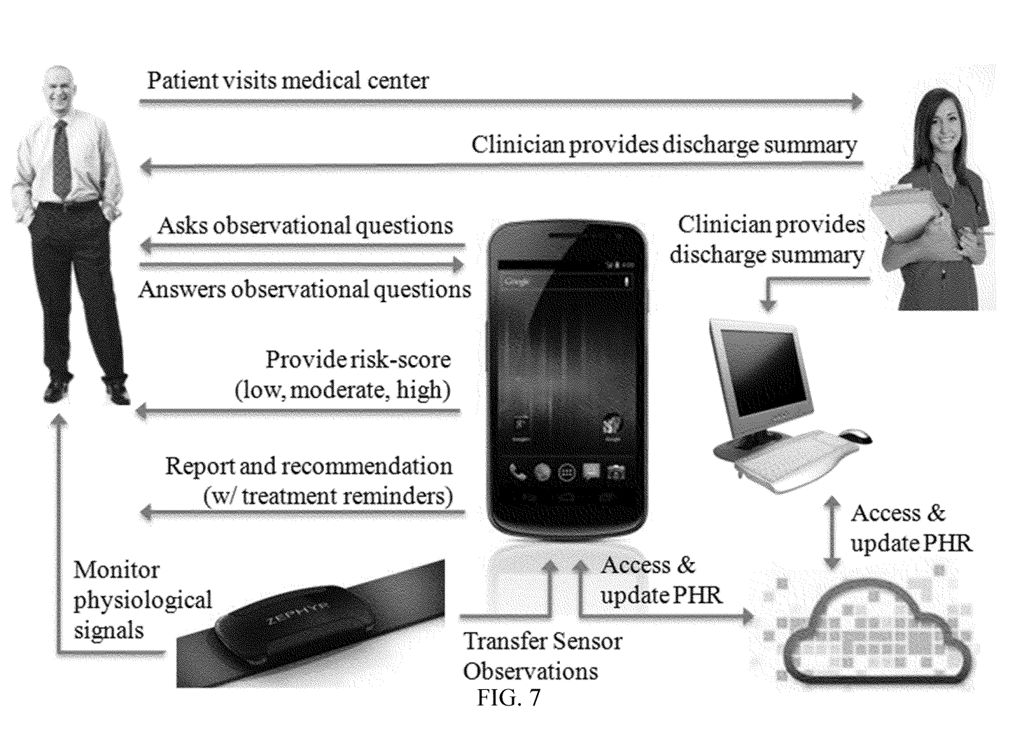

In the example scenario, after returning home, John ignores dietary restrictions and misses his medications. This results in rapid weight gain due to fluid retention. John begins to have a noticeable increase in respiratory rate and a decrease in oxygen saturation (SpO₂). The subject innovation can turn these collected data into high-level explanations, and alert both John and a clinician. A clinician reviews John's data from the sensors and proactively contacts him in order to determine that poor adherence is the cause of this deterioration, and advises him accordingly. John increases his dietary and medication adherence, preventing a readmission to the hospital. FIG. 7 illustrates interactions between patient, clinician, sensors, and mobile device associated with this example scenario.

The activity of observing symptoms and diagnosing a patient's condition is a perceptual act, routinely performed by a clinician. Now, with the advent of sensors, machines also have the ability to measure physiological signals and observe symptoms. Given this ability, many conventional systems simply provide access to raw data, through Internet or mobile access, leading to a deluge of incomprehensible data. What these systems lack, and the clinicians possess, is the ability to effectively glean semantics from observation, to apprehend entities from detected qualities—in short, to perceive.

In various embodiments, the subject innovation can apply semantic perception to convert health-related sensor data to knowledge through the integration of heterogeneous data and application of perceptual inference. The integration of heterogeneous sensor data can utilize Semantic Web technologies in general, and can utilize Semantic Sensor Web technologies in particular. The application of perceptual inference can utilize the ontology of perception discussed herein. One particular practical health application of the subject innovation is discussed below, which uses sensor, mobile, and semantic technologies.

To test the solutions to the challenges of semantic perception in healthcare, a semantics-enhanced sensor and mobile health app (application software) was implemented as an embodiment of the subject innovation. This app is capable of observing a patient's symptoms, semantically annotating the data, analyzing the data using medical domain knowledge encoded in a clinical cardiology ontology, and providing relevant and useful information to aid the patient and clinician in decision-making. The app was developed for the Android mobile operating system.

Cardiology knowledge base: A cardiology knowledge base was built by extracting knowledge from different sources available on the Web. The knowledge base was expressed in Resource Description Framework (RDF). The primary source of knowledge was the Unified Medical Language System (UMLS). UMLS is a comprehensive ontology of biomedical concepts designed and maintained by the U.S. National Library of Medicine. All disorders and symptoms in the knowledge base were extracted from UMLS. While UMLS provides the hierarchical relations between terms, it does not provide causal relations between symptoms and disorders. However, using the cardiology-related symptoms and disorders from UMLS, these causal relations were extracted from Healthline.com. Healthline.com is a website that provides access to vast amounts of health-related information. Finally, this knowledge base was vetted by domain experts at ezDI.com. The resulting cardiology knowledge base used by the example prototype embodiment contained 173 disorders, 284 symptoms, and 1944 causal relations between disorders and symptoms.

The sensors can measure physiological signals of the user and transmit to the application, running on the mobile device. Two types of sensing can be utilized, including both passive sensing and active sensing.

With passive sensing, low-cost, unobtrusive, on-body sensors continuously monitor the patient. These sensors are aptly referenced as “wear-em-and-forget-em” data tracking devices, and their use requires very little commitment from the user; they must simply wear the sensors, carry the mobile computing device (i.e., smart phone), and in some cases charge them (sensors and mobile devices). The types of sensors used include: heart-rate sensor, accelerometer, temperature sensor, and galvanic skin response sensor. A prototype embodiment was created with an accelerometer (from http://fitbit.com) and a heart-rate monitor (from http://www.zephyr-technology.com/consumer-hxm), although other embodiments can contain any of a variety of passive sensors. The data from the sensors can be automatically transferred to the mobile device, e.g., through a Bluetooth wireless connection, etc. The heterogeneous data from the different sensors can then be semantically annotated with concepts from the SSN ontology and cardiology ontology.

The low-level observations generated by these sensors can then be converted to useful and actionable knowledge (i.e., explanations). Through the mobile computing device, the user (patient or clinician) can always have the option to view the current conditions.

As an example, suppose that a patient is wearing a heart-rate sensor and a galvanic skin response sensor, resulting in the observations of tachycardia and clammy skin. Given these observed symptoms and the cardiology background knowledge, the subject innovation can generate a set of explanations including panic disorder, hypoglycemia, hyperthyroidism, myocardial infarction, and septic shock. The user and/or clinician may then surmise that, given the users recent history of heart disease, this set of explanations is troubling, resulting in follow up treatment.

Active sensing requires further participation and commitment by the user. The goal is to collect information from additional (active) sensors available to the user (e.g., weight scale, etc.) and observations made by the users themselves (e.g., feeling chest pain, etc.). This additional information can then be used to minimize the set of explanations (generated during the passive sensing phase). The types of sensors used in the prototype included a blood pressure monitor and a weight scale, though in various embodiments, substantially any sensors could be used as active sensors.

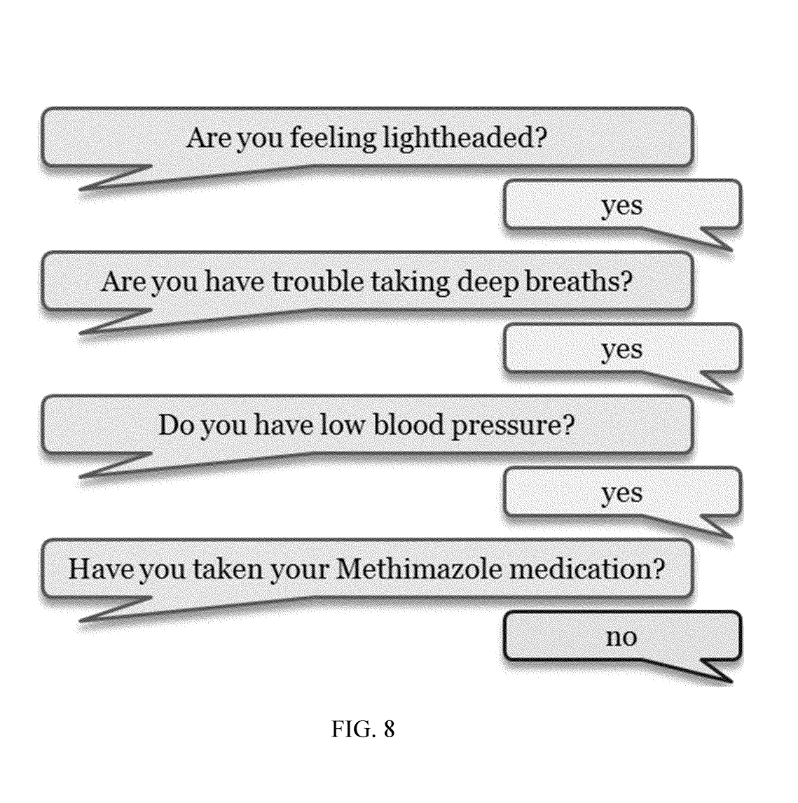

Contemporary services such as WebMD.com and HealthLine.com request that patients enter their symptoms into a Web form so that the system can provide additional information about potential causes. A better approach, as exemplified in the subject innovation, is to utilize the derived explanations from the passive sensing phase, together with the background knowledge and the focus functionality of IntellegO, to generate and ask relevant and targeted questions about the symptoms of the user. Such questions may require access to sensors available to the user at home (e.g., blood pressure monitor, etc.), or the questions may only be answerable by the user themselves (e.g., “Are you experiencing chest pain?”). This question-and-answer interaction between the application and user can proceed, for example, in the form of a common chat dialog, such as shown in FIG. 8, illustrating an example implementation of active sensing via a chat dialog, which can efficiently minimize the set of explanations (e.g., and can employ voice recognition of user answers, etc.), or can proceed via any of a variety of user interfaces (e.g., presenting a question and appropriate response options (e.g., as boxes, etc.) that can be selected via a user interface (e.g., touchscreen), etc.).

Continuing the previous example, where tachycardia and clammy skin observations were determined from the passive sensing phase, resulting in a set of explanations, including panic disorder, hypoglycemia, hyperthyroidism, myocardial infarction, and septic shock. To minimize this set of explanations, the example embodiment seeks informative observations (by asking questions) regarding lightheadedness, trouble breathing, and low blood pressure (since the patient has access to a blood pressure monitor), as shown in FIG. 8. With these additional observations (lightheaded, trouble taking deep breaths, low blood pressure, and the patient has not taken Methimazole medication), the subject innovation updates the explanations to include hypoglycemia and hyperthyroidism.

In various embodiments, the subject innovation can include a knowledge-enabled (semantic) application development framework with the ability to create advanced healthcare applications. Such embodiments can integrate data from passive and active sensing (including both machine and human sensors) with background knowledge from domain ontologies, semantic reasoning, and state of the art mobile communication and computing environments to help people make decisions to improve health, wellness, and fitness.

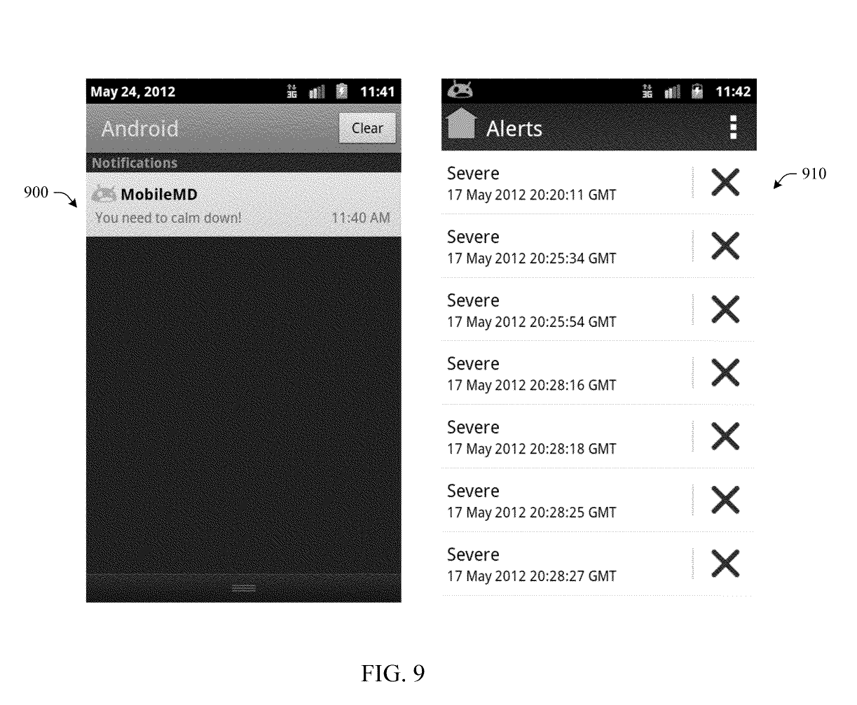

If a precarious situation is detected, systems and methods of the subject innovation can provide immediate response, such as by notifying the user, generating an alert, notifying a clinician, sending an automated request for emergency medical treatment, etc., or combinations thereof. FIG. 9 illustrates an example user interface showing user notification at 900 and example alerts at 910. For the example prototype discussed herein, the background knowledge needed to detect the precarious situation was defined in a cardiology ontology (although in various embodiments, other ontologies could be employed alternatively or additionally), which was used to semantically annotate the sensor data and infer current condition(s).

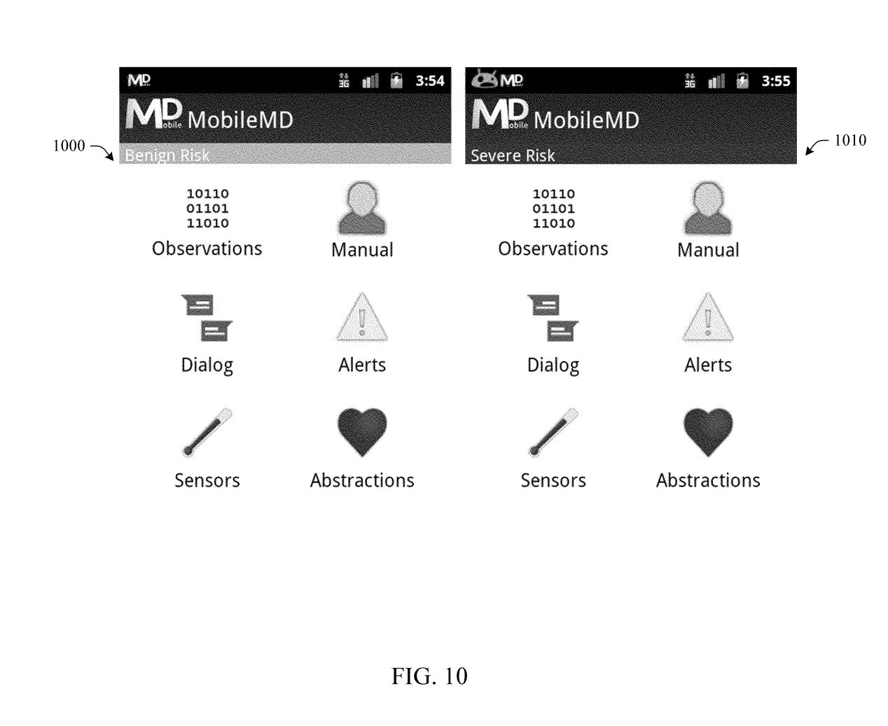

The primary interface screen can provide links to the different app screens, with an example embodiment shown in FIGS. 10 at 1000 and 1010, illustrating an example user interface of a health embodiment of the subject innovation. Additionally, as seen in FIG. 10, an indicator (e.g., a bar across the top, etc.) can specify the user's current condition, for example, whether it is benign (e.g., green), precarious (e.g., yellow), or severe (e.g., red).

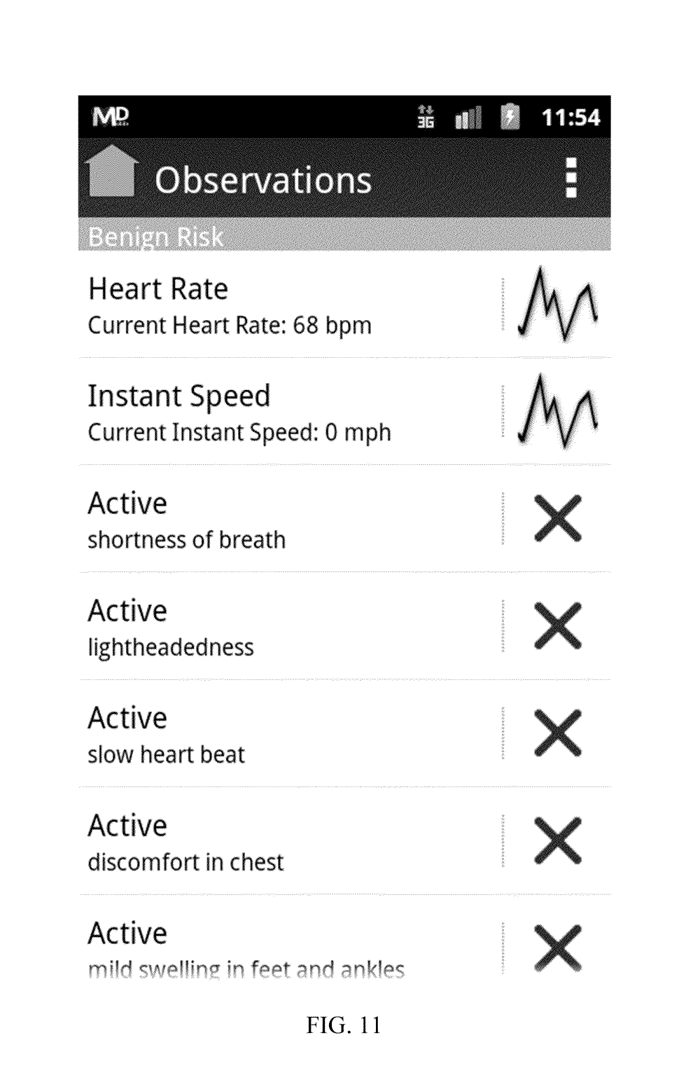

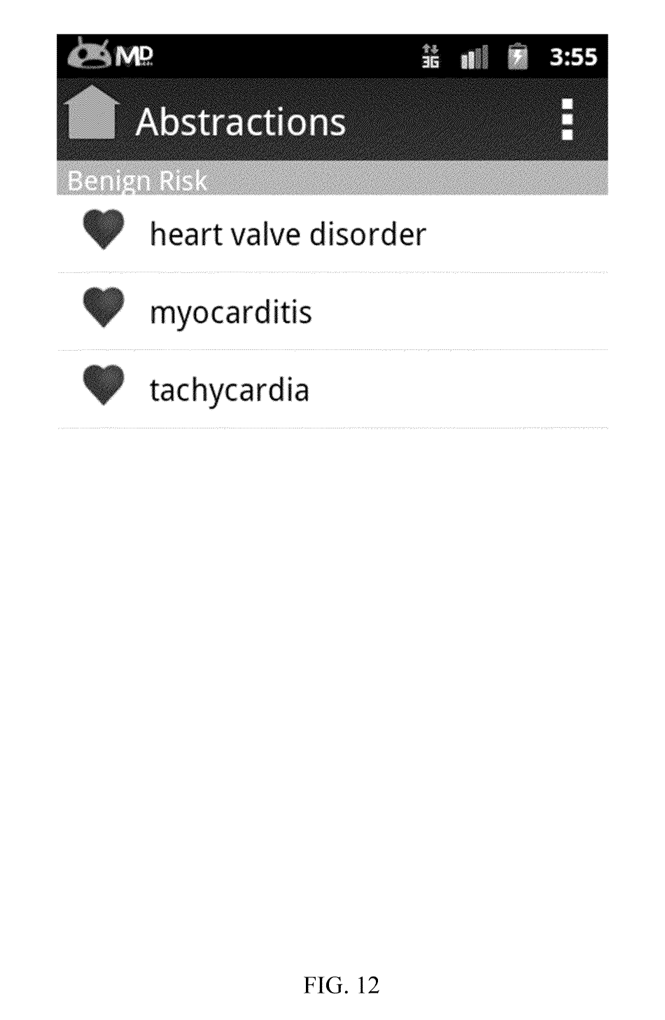

FIG. 11 illustrates observations and detected symptoms accessible via the example user interface. Machine observations, e.g., heart rate, can be seen in real time. Also, symptoms detected by the user can also be provided. FIG. 12 illustrates abstractions (or explanations), which are disorders that could be the cause of the observed symptoms (or account for the symptoms) via an example user interface.

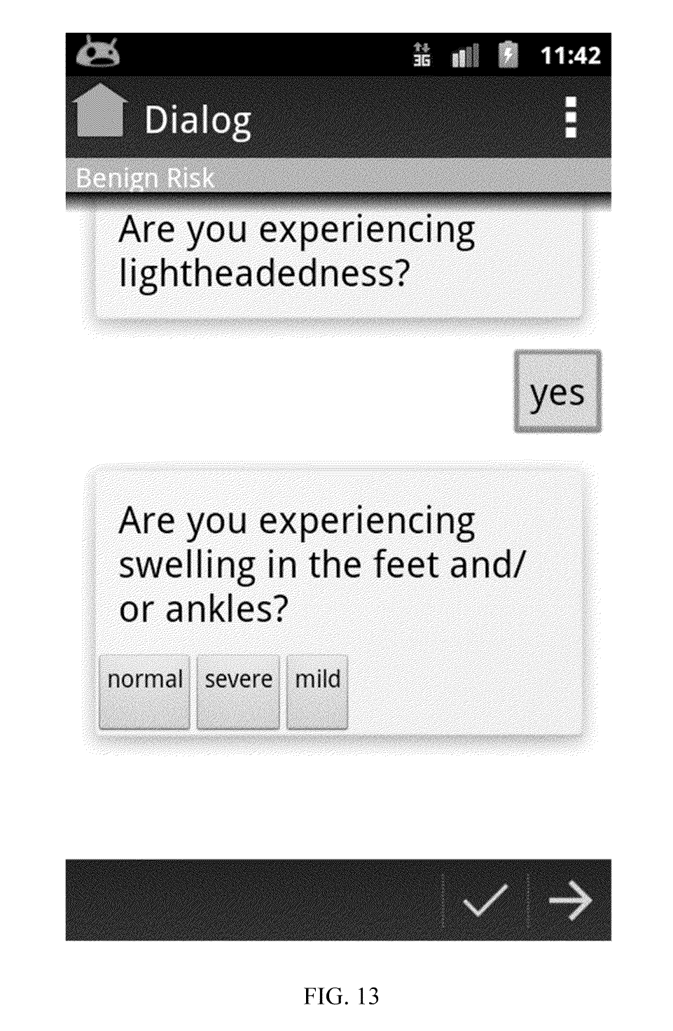

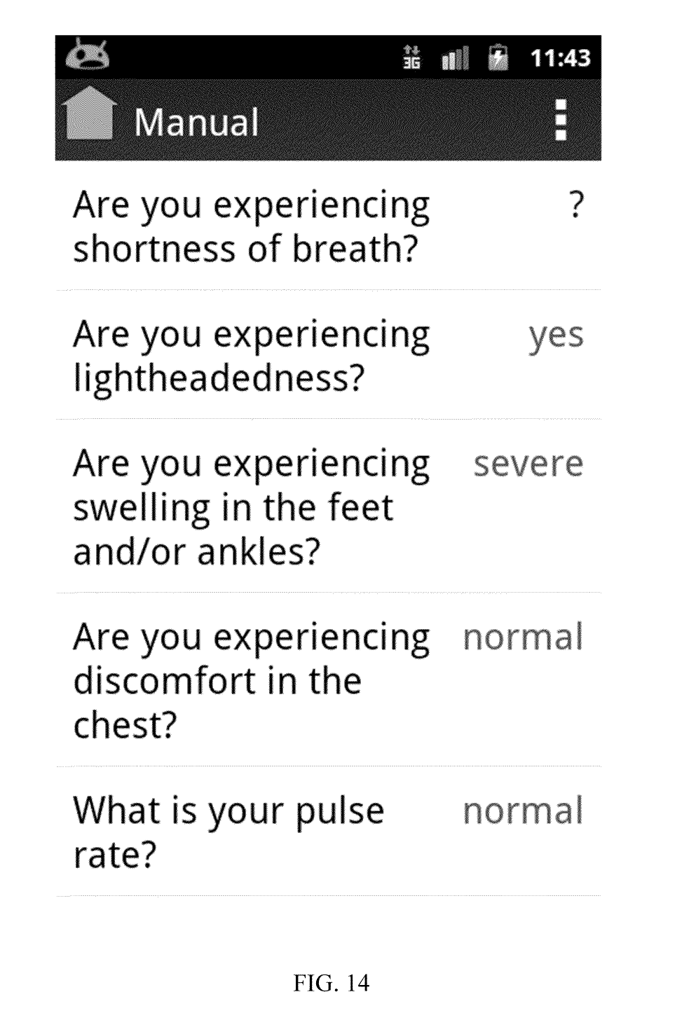

FIG. 13 illustrates a dialog interface in accordance with an example user interface. To narrow down the set of explanations, the application will ask the user specific questions through a dialog interface such as that of FIG. 13. Alternatively, FIG. 14 illustrates an example user interface for a user to manually enter symptoms.

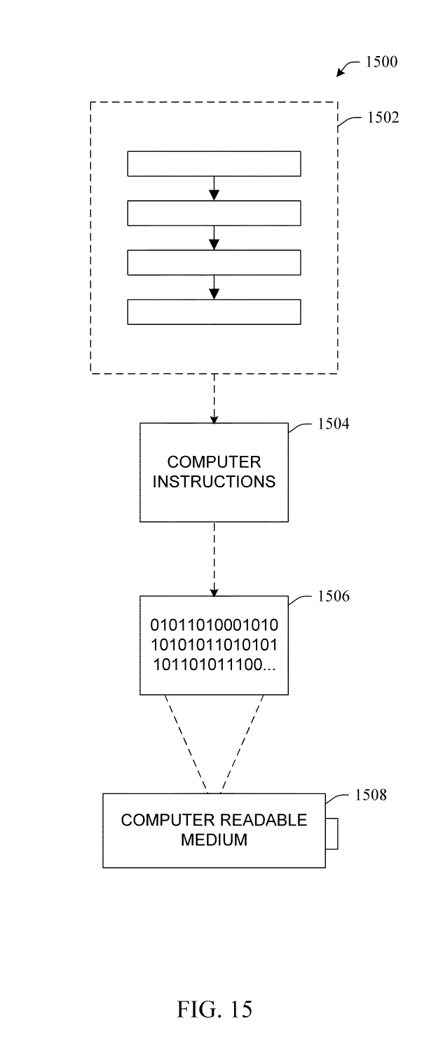

Still another embodiment can involve a computer-readable medium comprising processor-executable instructions configured to implement one or more embodiments of the techniques presented herein. An embodiment of a computer-readable medium or a computer-readable device that is devised in these ways is illustrated in FIG. 15, wherein an implementation 1500 comprises a computer-readable medium 1508, such as a CD-R, DVD-R, flash drive, a platter of a hard disk drive, etc., on which is encoded computer-readable data 1506. This computer-readable data 1506, such as binary data comprising a plurality of zero's and one's as shown in 1506, in turn comprises a set of computer instructions 1504 configured to operate according to one or more of the principles set forth herein. In one such embodiment 1500, the processor-executable computer instructions 1504 is configured to perform a method 1502, such as at least a portion of one or more of the methods described in connection with embodiments disclosed herein. In another embodiment, the processor-executable instructions 1504 are configured to implement a system, such as at least a portion of one or more of the systems described in connection with embodiments disclosed herein. Many such computer-readable media can be devised by those of ordinary skill in the art that are configured to operate in accordance with the techniques presented herein.

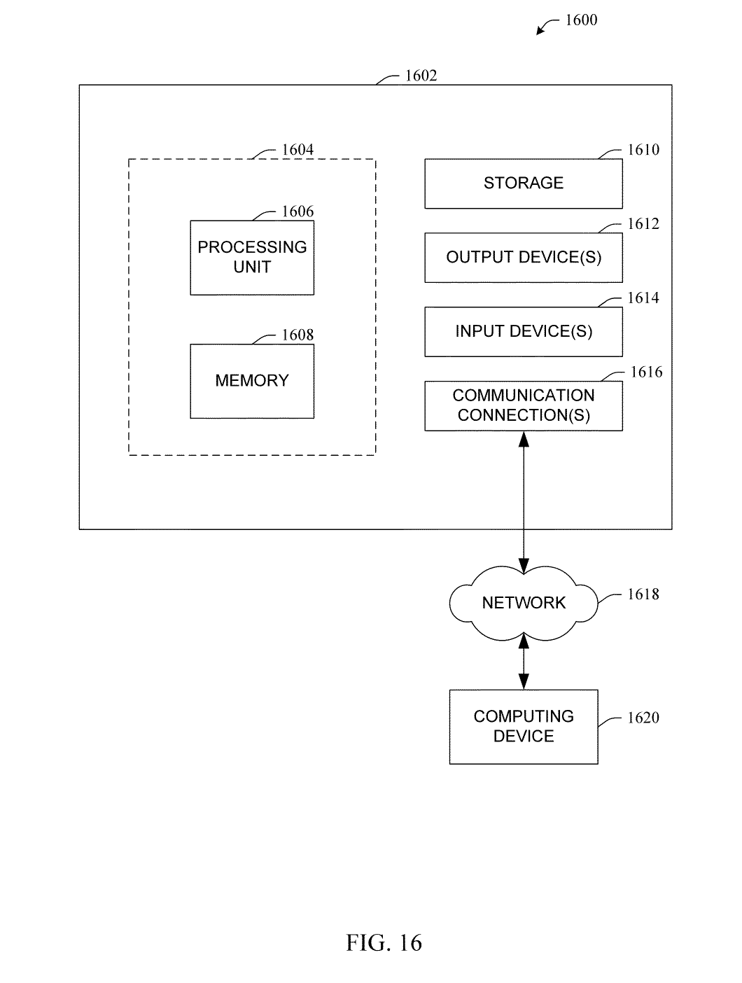

FIG. 16 and the following discussion provide a description of a suitable computing environment in which embodiments of one or more of the provisions set forth herein can be implemented. The operating environment of FIG. 16 is only one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, tablets, and the like, multiprocessor systems, consumer electronics, mini computers, mainframe computers, distributed computing environments that include any of the above systems or devices, and the like.

Generally, embodiments are described in the general context of “computer readable instructions” being executed by one or more computing devices. Computer readable instructions are distributed via computer readable media as will be discussed below. Computer readable instructions can be implemented as program modules, such as functions, objects, Application Programming Interfaces (APIs), data structures, and the like, that perform particular tasks or implement particular abstract data types. Typically, the functionality of the computer readable instructions can be combined or distributed as desired in various environments.

FIG. 16 illustrates a system 1600 comprising a computing device 1602 configured to implement one or more embodiments provided herein. In one configuration, computing device 1602 can include at least one processing unit 1606 and memory 1608. Depending on the exact configuration and type of computing device, memory 1608 may be volatile, such as RAM, non-volatile, such as ROM, flash memory, etc., or some combination of the two. This configuration is illustrated in FIG. 16 by dashed line 1604.

In these or other embodiments, device 1602 can include additional features or functionality. For example, device 1602 can also include additional storage such as removable storage or non-removable storage, including, but not limited to, magnetic storage, optical storage, and the like. Such additional storage is illustrated in FIG. 16 by storage 1610. In some embodiments, computer readable instructions to implement one or more embodiments provided herein are in storage 1610. Storage 1610 can also store other computer readable instructions to implement an operating system, an application program, and the like. Computer readable instructions can be loaded in memory 1608 for execution by processing unit 1606, for example.

The term “computer readable media” as used herein includes computer storage media. Computer storage media includes volatile and nonvolatile, removable and non-removable media implemented in any method or technology for storage of information such as computer readable instructions or other data. Memory 1608 and storage 1610 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1602. Any such computer storage media can be part of device 1602.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

Device 1602 can include one or more input devices 1614 such as keyboard, mouse, pen, voice input device, touch input device, infrared cameras, video input devices, or any other input device. One or more output devices 1612 such as one or more displays, speakers, printers, or any other output device can also be included in device 1602. The one or more input devices 1614 and/or one or more output devices 1612 can be connected to device 1602 via a wired connection, wireless connection, or any combination thereof. In some embodiments, one or more input devices or output devices from another computing device can be used as input device(s) 1614 or output device(s) 1612 for computing device 1602. Device 1602 can also include one or more communication connections 1616 that can facilitate communications with one or more other devices 1620 by means of a communications network 1618, which can be wired, wireless, or any combination thereof, and can include ad hoc networks, intranets, the Internet, or substantially any other communications network that can allow device 1602 to communicate with at least one other computing device 1620.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
an environmental knowledgebase that associates a set of features with a set of properties;
an interface component that receives sensor data associated with a set of observed properties, wherein the set of observed properties is a subset of the set of properties; and
a perception component that performs semantic perception on the set of observed properties based on the environmental knowledgebase, wherein the perception component comprises:
an explanation component that determines a set of explanatory features associated with the set of observed properties, wherein the set of explanatory features is a subset of the set of features that is associated with the set of observed properties.

2. The system of claim 1, wherein the set of explanatory features comprises at least two explanatory features, and wherein the perception component further comprises a discrimination component that determines a set of discriminatory properties associated with the set of explanatory features, wherein the set of discriminatory properties is a subset of the set of properties that is associated with the set of explanatory features, and wherein each discriminatory property of the set of discriminatory properties discriminates between at least two of the explanatory features.

3. The system of claim 2, wherein the communication component receives additional sensor data associated with a set of observed discriminatory properties, wherein the set of observed discriminatory properties is a subset of the set of discriminatory properties, and wherein the explanation component narrows the set of explanatory features based on the set of observed discriminatory properties.

4. The system of claim 3, wherein the discrimination component narrows the set of discriminatory properties based on the narrowed set of explanatory features and wherein the perception component implements a perception cycle that computes iteratively, and in an interleaved fashion, explanatory features and contextually relevant discriminatory observations to converge to an actionable minimum set of explanatory features.

5. The system of claim 1, further comprising a mapping component that lowers the set of observed properties to a bit vector representation, wherein the explanation component determines a set of explanatory features associated with the set of observed properties based on the bit vector representation.

6. The system of claim 1, wherein the perception component analyzes the set of explanatory features, and wherein the communication component generates at least one of an alert or a notification based on the analysis.

7. The system of claim 1, wherein the mapping component lifts the set of explanatory features to a semantic representation, and wherein the communication component presents the semantic representation of the set of explanatory features to a user.

8. The system of claim 1, wherein the mapping component lifts the set of explanatory features to a semantic representation, and wherein the communication component transmits the semantic representation of the set of explanatory features via a communications network.

9. The system of claim 1, further comprising one or more sensor components that record a first subset of the sensor data and transmit the first subset of the sensor data to the communication component.

10. The system of claim 1, wherein the communication component comprises a user interface, and wherein a second subset of the sensor data is received via the user interface.

11. The system of claim 9, wherein the second subset of the sensor data is received via a chat dialog.

12. A method, comprising:
receiving one or more observed properties;
lowering the one or more observed properties to a bit vector representation;
determining a set of explanatory features based on the one or more observed properties and an environmental knowledgebase that associates a set of properties with a set of features, wherein the set of explanatory features is a subset of the set of features;
lifting the set of explanatory features to a semantic representation; and
communicating the set of explanatory features.

13. The method of claim 12, wherein the set of explanatory features comprises two or more explanatory features, and further comprising determining a set of discriminatory properties based on the set of explanatory features, wherein the set of discriminatory properties is a subset of the set of properties.

14. The method of claim 12, further comprising implementing a perception cycle that computes iteratively, and in an interleaved fashion, explanatory features and contextually relevant discriminatory observations to converge to an actionable minimum set of explanatory features.

15. The method of claim 12, further comprising generating at least one of an alert or a notification based on the set of explanatory features.

16. The method of claim 12, wherein receiving one or more observed properties comprises receiving at least one observed property via a passive sensor.

17. The method of claim 12, wherein receiving one or more observed properties comprises receiving at least one observed property via a user interface.

18. A system, comprising:
an environmental knowledgebase that associates a set of medical conditions with a set of health characteristics, wherein each medical condition of the set of medical conditions is associated with one or more health characteristics of the set of health characteristics;
an interface component that receives sensor data associated with a set of observed health characteristics, wherein the set of observed health characteristics is a subset of the set of health characteristics; and
a perception component that performs semantic perception on the set of observed health characteristics based on the environmental knowledgebase, wherein the perception component comprises:
an explanation component that determines a set of explanatory medical conditions associated with the set of observed health characteristics, wherein the set of explanatory medical conditions is a subset of the set of medical conditions that is associated with the set of observed health characteristics; and
a discrimination component that determines a set of discriminatory health characteristics associated with the set of explanatory medical conditions, wherein the set of discriminatory health characteristics is a subset of the set of health characteristics that is associated with the set of explanatory medical conditions, and wherein each discriminatory health characteristic of the set of discriminatory health characteristics discriminates between at least two of the explanatory medical conditions,
wherein the perception component implements a perception cycle that computes iteratively and in an interleaved fashion explanatory features and contextually relevant discriminatory observations to converge to minimum explanation for action.

19. The system of claim 18, wherein the interface component comprises a chat dialog, wherein at least a subset of the sensor data is received via the chat dialog.

20. The system of claim 18, wherein the interface component generates at least one of an alert or a notification based on the set of explanatory medical conditions.

21. The system of claim 20, wherein the environmental knowledgebase is encoded in a bit-matrix representation and observed properties, explanatory features, and discriminating properties of the environmental knowledgebase are encoded in bit-vector representations for efficient storage and computation on resource-constrained devices.
